(19) United States
(12) Patent Application Publication
(10) Pub. No.: US 2018/0257215 A1
(43) Pub. Date: Sep. 13, 2018

(54) TOOL FOR REMOVAL AND INSTALLATION OF A VEHICLE SUBFRAME

(71) Applicants: Joey Vicuna, Whittier, CA (US); Joey James Vicuna, JR., Whittier, CA (US)

(72) Inventors: Joey Vicuna, Whittier, CA (US); Joey James Vicuna, JR., Whittier, CA (US)

(21) Appl. No.: 15/453,379

(22) Filed: Mar. 8, 2017

(51) Int. Cl. B25H 5/00

(52) U.S. Cl. CPC B25H 5/00

(57) ABSTRACT

A tool, for removal and installation of a vehicle subframe, includes a center spine having a first end, a second end and an upper surface, a mounting pad, defining a plurality of apertures, secured to the center spine, a tool crossmember defining a channel having upwardly extending sidewalls on either side thereof, a bracket having a pair of upwardly extending bracket walls and means for adjusting a space defined between the upwardly extending walls, and an adjustable attachment for the bracket operative between the bracket and the center spine to vary the distance between the crossmember and the bracket;

### FIELD OF THE INVENTION

The present invention relates generally to vehicle service and repair activities and relates particularly to the tools and apparatus utilized for performing such services and repairs upon vehicles having structural elements such as subframes.

### BACKGROUND OF THE INVENTION

As practitioners in the vehicle design arts have endeavored to provide vehicle structures that are stronger and yet lighter in weight, substantial changes in the fabrication of vehicles such as small trucks and automobiles have become necessary. One aspect of vehicle fabrication that has undergone dramatic changes due to these efforts to lighten and strengthen vehicles is generally described as the “support frame”. Traditionally, the construction of vehicles has been described as a “body on frame construction” so described due to its use of a strong rigid and typically heavy vehicle frame to which the suspension and the drive apparatus have been secured. A separate vehicle body is then secured upon the support frame to complete the vehicle. While this method of construction provides a strong, rigid and durable vehicle, it also causes the vehicle to be extremely heavy.

As vehicle designers and fabricators became subjected to increasing pressure to achieve greater efficiency and fuel economy as well as vehicle speed and performance, it became a primary objective of vehicle designers and fabricators to achieve reduced vehicle weight while maintaining the strength and rigidity of the vehicle. In addition, various governing agencies further regulated vehicle manufacture to include increased crash protection and passenger safety.

To achieve the fabrication of vehicles that are simultaneously lighter in weight while maintaining vehicle strength and crash protection, vehicle designers dramatically changed the fabrication of vehicles. The prevailing design and fabrication system employed on modern vehicles utilizes an integrated body and frame construction often referred to in the art as a “monocoque” construction, also referred to in the art as a “unibody” construction. In such constructions, the vehicle body and supporting frame are integrally formed and typically fabricated of multiple stamped metal components which are joined by welding techniques.

As vehicle designers and fabricators sought to achieve lighter vehicle supporting structures, the strength and rigidity of the vehicle began to be compromised. To meet these problems, vehicle designers and fabricators introduced supplementary frame members which functioned to strengthen specific portions of the vehicle support system. Such supplementary frame members became generally known in the art as “subframes” and are typically formed of high strength metal and are secured to portions of the vehicle support structure utilizing high strength bolts or other equivalent fasteners. Subframes have proven to be highly successful in maintaining reduced vehicle weight while strengthening localized areas of the vehicle support structure that are subject to high stress. Thus, subframes often function in areas such as the underside of the engine and transmission compartment of the vehicle in a manner allowing them to transfer stress and localized forces such as engine torque or suspension torque to stronger load bearing areas.

Subframes have become widely used within the vehicle industry and have proven to provide greatly increased vehicle support member strength without unduly increasing vehicle weight. Unfortunately, subframes often are secured to the underside of the vehicle body at locations which block access to vehicle components and obscure observation of certain portions of the vehicle. As a result, vehicle repair and service activities are often impeded by the presence of subframes. This in turn, necessitates the temporary removal of such subframes in order to accomplish repair and maintenance activities.

Because the fabrication of typical subframes in use today requires high strength, subframes tend to be heavy, large in size and cumbersome to manipulate during removal and reinstallation by service personnel. In a typical vehicle service and maintenance facility, at least two, and more often three, service personnel are required to carry out the removal and reinstallation of a typical subframe such as the subframe located beneath the vehicle engine and transmission components. The size and weight of such subframes usually requires a pair of service technicians to support the subframe weight while a third removes the subframe fasteners during subframe removal. When the subframe is reinstalled following the required vehicle service or maintenance, three service technicians are again required with two technicians lifting, supporting and positioning the subframe beneath the vehicle while the third technician secures the subframe using bolts or other fasteners.

The need to utilize three service technicians to remove and reinstall a subframe greatly increases the cost of service and maintenance activities. Many smaller vehicle repair and service facilities cannot support having three service technicians available at the same time within the facility. This may preclude effective management and profitability of smaller vehicle repair and maintenance facilities. Even in larger repair and maintenance facilities having greater numbers of service and repair technicians available at any given time, the use of three service technicians to perform this single function is extremely costly. This, in turn, reduces the profitability of the service and repair facility. In addition to impeding the performance of smaller vehicle service and repair facilities and negatively impacting the profitability of larger service and repair facilities, the safety of the service and repair technicians is unduly compromised. The presence of three service technicians operating beneath a vehicle which has been raised by a vehicle hoist to facilitate removal or installation of a subframe beneath the vehicle engine and transmission area subjects the service technicians to potential injury in the event the heavy subframe is mishandled or dropped during the operation. The weight and size of the heavy metal subframe falling from beneath the vehicle can impart serious injury to the service technicians.

There arises therefore an extensive and unresolved need in the vehicle service and repair arts for a more cost-effective and safe system and apparatus for use in the removal and reinstallation of heavy subframes within vehicle service and repair facilities.

### SUMMARY OF THE INVENTION

Accordingly, it is a general object of the present invention to provide an improved cost-effective and safe system and apparatus for the removal and reinstallation of heavy subframes beneath vehicles during service and maintenance activities. It is a more particular object of the present invention to provide an improved cost-effective and safe system and apparatus for the removal and reinstallation of heavy subframes beneath vehicles during service and maintenance activities that avoids the need for the use of multiple service technicians beneath a vehicle during the removal or reinstallation of subframes. It is a still more particular object of the present invention to provide an improved cost-effective and safe system and apparatus for the removal and reinstallation of heavy subframes beneath vehicles during service and maintenance activities that avoids exposing service technicians moving beneath vehicles having removal or reinstallation of subframes to potential safety hazards arising out of the miss handling or falling of such subframes.

In accordance with the present invention, there is provided a tool for use in removing and installing a vehicle subframe, having first and second subframe crossmembers, from and upon a host vehicle, the tool comprising: a center spine having a first end, a second end and an upper surface; a mounting pad, defining a plurality of apertures, secured to the center spine; a tool crossmember defining a channel having upwardly extending sidewalls on either side thereof; a bracket having a pair of upwardly extending bracket walls and means for adjusting a space defined between the upwardly extending walls; and adjustable attachment means operative between the bracket and the center spine to vary the distance between the crossmember and the bracket, the tool being secured to a jack pedestal and being positioned beneath a host vehicle having a removable subframe such that the first subframe crossmember is received within the tool crossmember and such that the second subframe crossmember is received between the bracket walls, whereby the vehicle subframe is supported upon the tool during removal and installation of the vehicle sub frame from and upon a host vehicle.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a perspective view of a tool for removal and installation of a vehicle subframe constructed in accordance with the present invention;

FIG. 2 sets forth a bottom view of the present invention tool for removal and installation of a vehicle subframe;

FIG. 3 sets forth a perspective view of the present invention tool for removal and installation of a vehicle subframe positioned beneath an illustrative vehicle;

FIG. 4 sets forth a perspective view of the present invention tool for removal and installation of a vehicle subframe positioned beneath a typical vehicle subframe;

FIG. 5 sets forth a perspective view of the present invention tool for removal and installation of a vehicle subframe supporting an illustrative vehicle subframe; and

FIG. 6 sets forth a perspective view of an alternate embodiment of the present invention tool for removal and installation of a vehicle subframe.

### DESCRIPTION OF THE PREFERRED EMBODIMENTS OF THE INVENTION

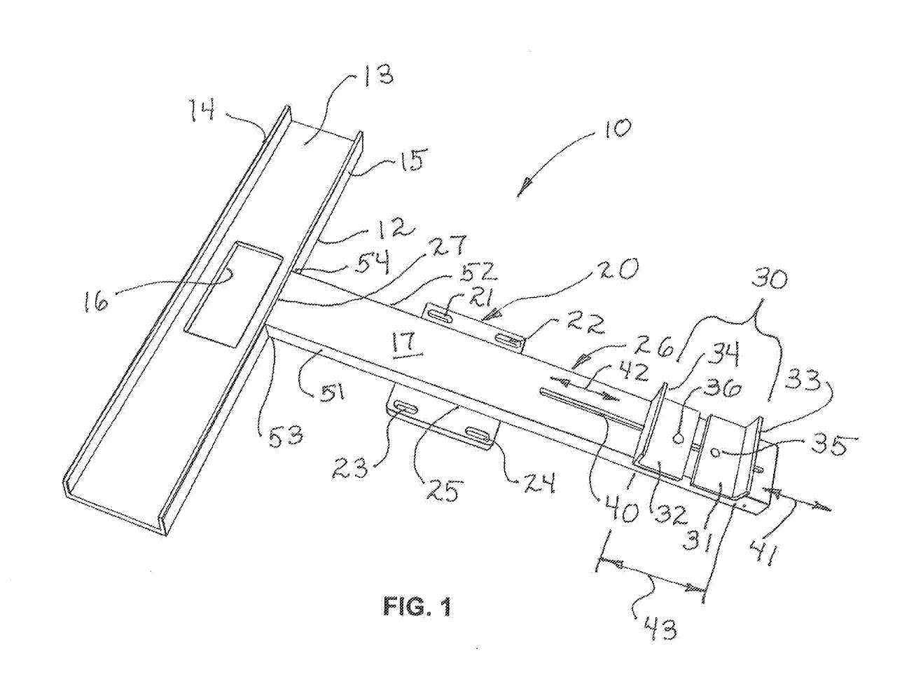

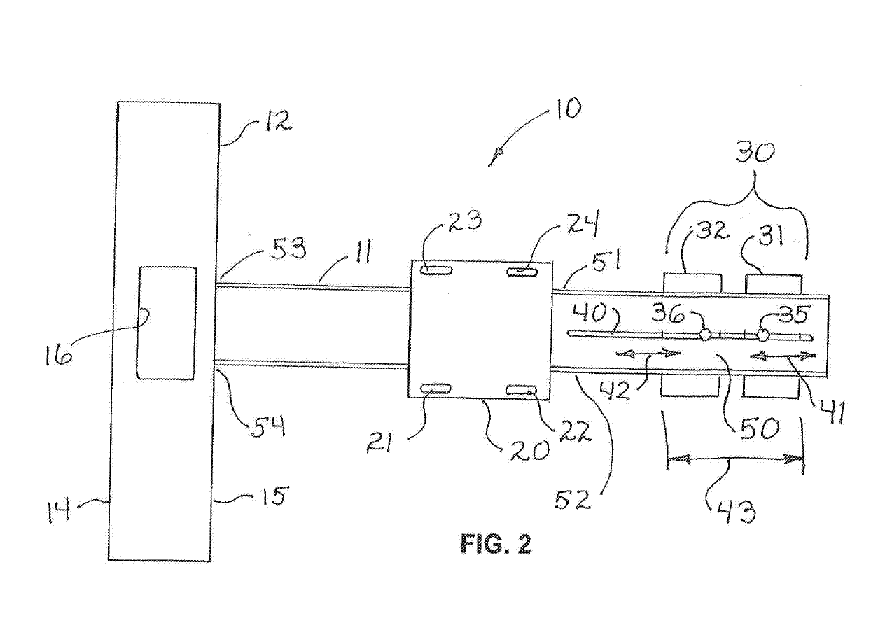

FIG. 1 sets forth a perspective view of a tool for removal and installation of a vehicle subframe constructed in accordance with the present invention and generally referenced by numeral 10. Tool 10 includes an elongated center spine 11 having one end joined to a crossmember 12. Spine 11 is formed of a rigid metal material such as aluminum, or the like, and defines a pair of downwardly extending sidewalls 51 and 52 (sidewall 52 better seen in FIG. 2). Center spine 11 further defines an elongated slot 40 and a top surface 17. Tool 10 further includes a bracket 30 formed by a pair of independently movable bracket segments 31 and 32. Bracket segment 31 forms a rear bracket segment and is movably secured upon surface 17 by a conventional threaded fastener 35. Fastener 35 is a conventional nut and bolt combination, or its equivalent, and extends through slot 40. Rear bracket segment 31 further defines an upwardly extending wall 33. Bracket segment 32 forms a front bracket segment which is a mirror image of bracket segment 31. Thus, front bracket segment 32 includes a vertically extending wall 34 and is movably secured upon surface 17 by a conventional fastener 36 which extends through slot 40.

Tool 10 further includes a mounting pad 20 formed of a generally planar and generally square metal plate having a plurality of the elongated slots 21, 22, 23 and 24 formed proximate the corners thereof. Mounting pad 20 is secured to sidewalls 51 and 52 of spine 11 by conventional weld joints 25 and 26 (weld joint 26 not seen in FIG. 1). In the preferred fabrication of the present invention, mounting pad 20 is positioned at the general center of spine 11. However, it will be apparent to those skilled in the art that the position of mounting pad 20 upon spine 11 may be altered to suit specific applications of the present invention tool without departing from the spirit and scope of the present invention.

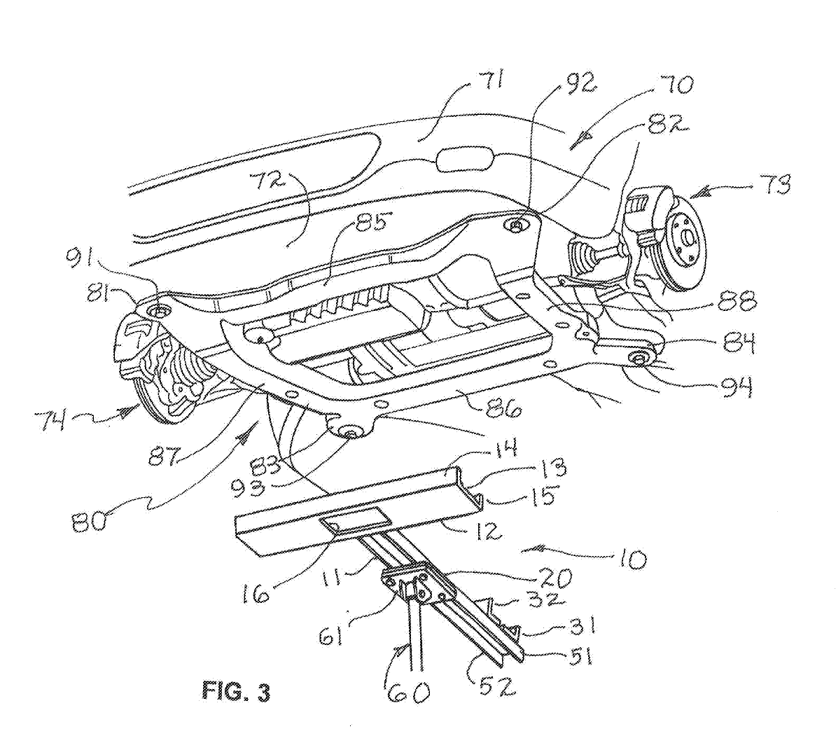

Crossmember 12 is preferably formed of an elongated generally U-shaped cross section member defining a channel 13 therein. A pair of sidewalls 14 and 15 extend upwardly to define the side portions of channel 13. An aperture 16 is formed at the approximate center of channel 13 to provide access to portions of the vehicle underside during utilization of tool 10 in the manner set forth below in FIGS. 3, 4 and 5. Crossmember 12 is secured to the forward end of spine 11 by a plurality of weld attachments 27, 53 and 54 (weld 54 seen in FIG. 2).

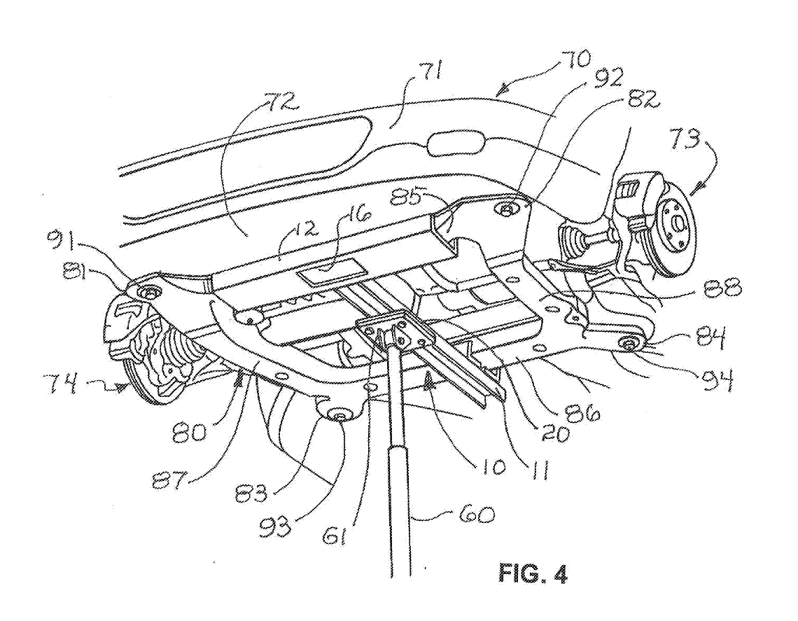

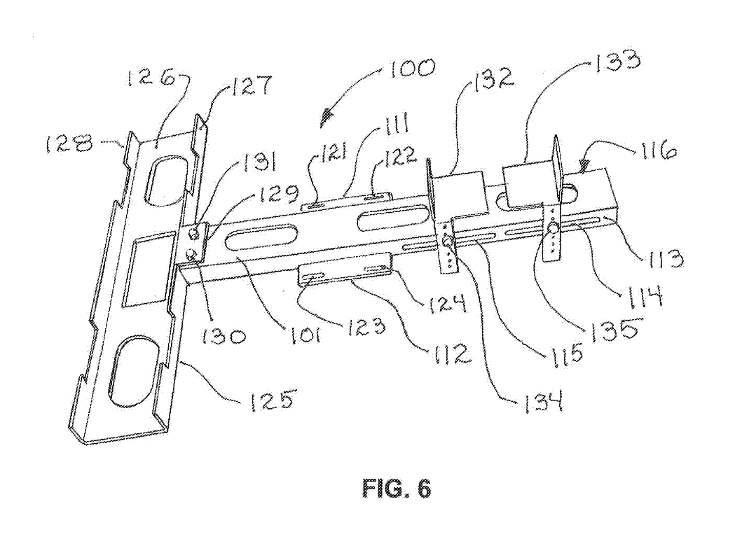

During the utilization of tool 10 set forth and described below in greater detail, tool 10 is secured upon a mounting pedestal of a transmission jack or floor jack of the type typically utilized in vehicle service facility by securing conventional fastening bolts to the pedestal passing through slots 21 through 24. Additionally, the positions of bracket segments 31 and 32 upon surface 17 is adjusted by loosening fasteners 35 and 36 respectively. With fasteners 35 and 36 loosened, bracket 30 may be moved upon surface 17 to fit the particular subframe which is to be removed and or install. Toward this end, it will be noted that rear bracket segment 31 and front bracket segment 32 are movable upon surface 17 in the directions indicated by arrows 41 and 42. In this manner the position of bracket 30 with respect to crossmember 12 is adjusted to accommodate the front-to-back span of the subframe (seen in FIG. 4). In addition, the independent positioning of rear bracket segment 31 and front bracket segment 32 facilitates adjustment of the width of bracket 30 as indicated by arrow 43. This degree of adjustability for bracket 30 facilitates the accommodation of a substantial variety of subframe dimensions and constructions. The use of elongated slots 21 through 24 in mounting pad 20 facilitates accommodation of variations of mounting pedestals for the various transmission jacks and floor jacks with which the present invention tool is operated. In the preferred fabrication of the present invention, spine 11, crossmember 12, mounting pad 20 and bracket 30 are formed of a high strength rigid material such as metal, or the like. In the fabrication shown in FIG. 1 these elements of tool 10 are fabricated of a high strength aluminum material. In the embodiment of the present invention set forth below in FIG. 6 these elements are formed of a stamped metal such as steel or steel alloys. Notwithstanding the preference for metal component fabrication expressed herein, it will be recognized by those skilled in the art that the present invention tool may be fabricated of other rigid high strength materials such as carbon fiber, or the like, without departing from the spirit and scope of the present invention.

FIG. 2 sets forth a bottom view of tool 10. As described above, tool 10 includes a center spine 11 joined to a crossmember 12 by a pair of weld joints 53 and 54. As is also described above crossmember 12 defines an aperture 16 together with sidewalls 14 and 15. Mounting pad 20 is secured to spine 11 by conventional weld joints 25 and 26 (weld joint 26 not shown). Mounting pad 20 defines a flat bottom surface 55 and a plurality of elongated slots 21 through 24. It will be noted that in the embodiment of the present invention shown in FIG. 2, mounting pad 20 defines a generally square shape. This square shape is a matter of design choice and is selected to best suit the various pedestals upon which the present invention is to be secured for use in combination with otherwise conventional floor jacks or transmission jacks. It will be apparent to those in the art, however, that different shapes for mounting pad 20 may be utilized without departing from the spirit and scope of the present invention.

Spine 11 defines a generally U-shaped member forming a channel 50 between a pair of downwardly extending sidewalls 51 and 52. As is described above, an elongated slot 40 is formed in channel 50 of spine 11. As is also described above, tool 10 includes a bracket 30 formed of independently movable bracket segments 31 and 32 each independently secured upon spine 11 by fasteners 35 and 36 extending through slot 40. In accordance with this adjustable feature, the independent positions of both bracket segments 31 and 32 are adjustable in the manner indicated by arrows 41 and 42. As is also described above, the positions of bracket segments 31 and 32 are, in addition to being movable in a front-to-back direction to accommodate the dimensions of the subframe, also movable with respect to each other to define a width 43 which further accommodates the dimensions of the subframe.

FIG. 3 sets forth a bottom perspective view of a conventional vehicle generally referenced by numeral 70 supporting a typical subframe 80. FIG. 3 also sets forth a bottom perspective view of tool 10 secured upon a jack 60 and jack pedestal 61 so as to rest upon mounting pad 20 of tool 10. As described above, tool 10 is secured to jack pedestal 61 by a plurality of conventional nut and bolt type fasteners, or the like. FIG. 3 is provided to illustrate the typical operating environment within which tool 10 is utilized to remove and install a conventional subframe situated upon the underside of a host vehicle. In the illustration shown in FIG. 3, vehicle 70 will be understood to be entirely conventional in fabrication and will be further understood to include operative elements such as a front bumper 71 and a supporting frame structure 72. The details of frame structure 72 are not shown but will be understood to be entirely conventional in fabrication. Of importance with respect to the present invention is the attachment of subframe 80 to support frame 72 of vehicles 70 utilizing a plurality of high strength bolts 91, 92, 93 and 94. In all respects, vehicle 70 is provided for illustration and not by way of limitation in the structure or utilization of the present invention.

More specifically, vehicle 70 further supports a left front suspension assembly 73 and a right front suspension assembly 74. Subframe 80 includes a plurality of attachment flanges 81, 82, 83 and 84. In the illustration shown, subframe 80 defines a generally square shape having a front crossmember 85 extending between attachment flanges 81 and 82, a rear crossmember 86 extending between attachment flanges 83 and 84, a side member 87 extending between attachment flanges 81 and 83 and a side member 88 extending between attachment flanges 82 and 84. As mentioned above, subframe 80 is formed of a strong rigid material such as steel or other metal material and is, as a result, substantial in weight. As is also mentioned above, a plurality of high strength bolts 91 through 94 are passed through attachment flanges 81 through 84 respectively and secured within conventional threaded passages (not shown) formed within or secured to support frame 72. Thus, in the underside perspective view shown in FIG. 3, it will be apparent that the attachment of subframe 80 beneath vehicles 70 obscure's substantial portions of the operative mechanism of the vehicle. It will be equally apparent that the attachment of subframe 80 also inhibits the ability of service personnel attempting the removal or installation of major components through the underside of vehicle 70.

In FIG. 3, tool 10 is shown supported upon pedestal 61 of an otherwise conventional floor jack or transmission jack 60 by a plurality of bolt fasteners securing pad 20 to pedestal 61. As described above, tool 10 includes a spine 11 supporting a crossmember 12 which, in turn, defines a channel 13 and upwardly extending sidewalls 14 and 15. Crossmember 12 further defines an aperture 16. As is also described above, spine 11 of tool 10 supports a pair of bracket segments 31 and 32 which combine to form a bracket 30. Both bracket segments 31 and 32 are adjustable both in width and position upon spine 11. Spine 11 is generally U-shaped and defines sidewalls 51 and 52.

FIG. 4 sets forth a bottom perspective view of tool 10 positioned beneath subframe 80 of vehicle 70. As described above, vehicle 70 is entirely conventional in fabrication and is comprised of a front bumper 71, a support frame 72 and a pair of front suspension assemblies 73 and 74 together with a subframe 80 secured thereto by a plurality of high strength bolts 90 through 94. As is also set forth above, subframe 80 defines a generally square structure having a front crossmember 85, a rear crossmember 86, a side member 87 and a side member 88 extending between attachment flanges 81 through 84.

In the illustrations set forth in FIG. 4, tool 10 has been positioned beneath vehicle 70 such that tool 10 is aligned with front crossmember 85 and rear crossmember 86 of subframe 80. Thereafter, jack 60 is operated to raise tool 10 upwardly beneath subframe 80 such that front crossmember 85 is received within channel 13 of crossmember 12 and such that rear crossmember 86 of subframe 80 is received within bracket 30. It will be noted that prior to utilization of tool 10, the operator will have determined the proper positions for bracket segments 31 and 32 in order to properly position bracket 30 in alignment with rear crossmember 86. In addition, the operator will have determined the width of crossmember 86 and positioned the relative distance between bracket segments 31 and 32 to accommodate and receive rear crossmember 86 between bracket segments 31 and 32. In the position shown in FIG. 4, the operator may adjust the upward force of jack 60 to securely position tool 10 against the underside of subframe 80. Once tool 10 has been properly positioned, this same operator is able to remove bolt fasteners 91 through 94 and thereby release subframe 80 from vehicle support frame 72. In accordance with an important aspect of the present invention, it will be noted that the utilization of tool 10 upon jack 60 frees the operator to remove the subframe attachment bolts without the assistance of additional technicians. It will be further noted that during the operator's activities of removing the subframe attachment bolts, tool 10 together with jack 60 continues to safely and reliably support subframe 80 thereby avoiding any risk of injury to the operator.

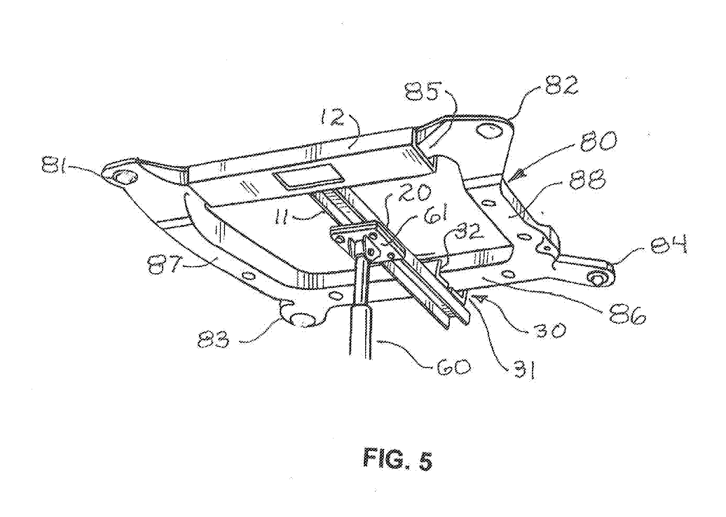

FIG. 5 sets forth a bottom perspective view of subframe 80 resting within tool 10. In the perspective view shown, tool 10 supporting subframe 80 has been lowered by operation of supporting floor jack 60 and has been completely removed from vehicle 70 (seen in FIG. 3). At this point subframe 80 may be lifted from tool 10 and stored at a convenient location. Alternatively, tool 10 may continue to support subframe 80 and remain positioned for reinstallation within the vehicle. In either event, it will be noted that subframe 80 is easily moved within the service facility and may be re-aligned beneath the vehicle for reinstallation by a single service technician. Once the repairs and maintenance have been performed upon the vehicle, the operator simply repositions jack 60, tool 10 and subframe 80 beneath vehicle 70 such that attachment flanges 81 through 84 are properly position. As a final step, the operator raises jack 60, lifting subframe 80 against the underside of the vehicle, and may then reinstall attachment bolts 91 through 94 (seen in FIG. 3). With subframe 80 properly installed, the operator simply lowers jack 60 and removes tool 10 from the jack pedestal.

FIG. 6 sets forth a perspective view of an alternate embodiment of the present invention tool for removal and installation of a vehicle subframe generally referenced by numeral 100. Tool 100 is fabricated of a stamped metal construction and is preferably formed of a high strength metal such as steel or the like. The structure and operation of tool 100 is virtually identical to the structure and operation of tool 10 set forth above with the differences being found in those that result from the use of stamped metal components rather than welded aluminum components. In all other respects however, it will be understood that the illustrations and descriptions as well as the operations of tool 10 set forth above apply equally well and with equal force to tool 100.

More specifically, tool 100 includes a center spine 101 formed of a generally U-shaped stamped metal member having a pair of outwardly extending support pad flanges 111 and 112. Tool 100 further includes a crossmember 125 defining a generally U-shaped member having a channel 126 and upwardly extending sidewalls 127 and 128. Crossmember 125 further includes a flange 129 which is joined to the forward end of spine 101 by a pair of conventional bolt fasteners 130 and 131. Spine 101 further includes a pair of downwardly extending sidewalls 113 and 116 (sidewall 116 not seen). While sidewall 116 is not seen due to the perspective view of FIG. 6, it will be understood to be identical to sidewall 113 and will be further understood to complete the U-shaped cross section of spine 101. Tool 100 further includes a pair of bracket segments 132 and 133 supported upon spine 101 by a plurality of attachment bolts such as bolts 134 and 135. The attachment bolts supporting bracket segments 132 and 133 pass-through elongated slots such as slots 114 and 115 formed in sidewall 113. Once again it will be understood that spine 101 also includes a second downwardly extending sidewall 116 which is identical to sidewall 113. Bracket segments 132 and 133 are adjustable in position upon spine 101 and in relative distance between the bracket segments. In this manner, the adjustable positioning of bracket segments 132 and 133 facilitates the accommodation of differing dimensions in the various subframes upon which tool 100 is utilized.

As mentioned above, tool 100 is substantially identical to tool 10 in its structure, function and operation apart from the use of stamped metal components to fabricate tool 100. Accordingly it will be apparent to those skilled in the art that crossmember 125 is the direct equivalent of crossmember 12 of tool 10 set forth above. Similarly, it will be apparent that spine 101 of tool 100 is substantially equivalent to spine 11 of tool 10 set forth above. By further similarity, it will be apparent that support pad flanges 111 and 112 are equivalent to mounting pad 20 of tool 10 set forth above. Finally, it will be apparent that bracket segments 132 and 133 of tool 100 are equivalent to bracket segments 31 and 32 of tool 10 also described above. It will be further understood that tool 100 functions in the same manner as tool 10 set forth and described above.

What has been shown is an improved cost-effective and safe system and apparatus for the removal and reinstallation of heavy subframes beneath vehicles during service and maintenance activities that avoids the need for the use of multiple service technicians beneath a vehicle during the removal or reinstallation of subframes. The apparatus for the removal and reinstallation of heavy subframes beneath vehicles during service and maintenance activities shown and described also avoids exposing service technicians moving beneath vehicles having removal or reinstallation of subframes to potential safety hazards arising out of the miss handling or falling of such subframe.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A tool for use in removing and installing a vehicle subframe, having first and second subframe crossmembers, from and upon a host vehicle, said tool comprising:
a center spine having a first end, a second end and an upper surface;
a mounting pad, defining a plurality of apertures, secured to said center spine;
a tool crossmember defining a channel having upwardly extending sidewalls on either side thereof;
a bracket having a pair of upwardly extending bracket walls and means for adjusting a space defined between said upwardly extending walls; and
adjustable attachment means operative between said bracket and said center spine to vary the distance between said crossmember and said bracket,
said tool being secured to a jack pedestal and being positioned beneath a host vehicle having a removable subframe such that the first subframe crossmember is received within said tool crossmember and such that said second subframe crossmember is received between said bracket walls,
whereby said vehicle subframe is supported upon said tool during removal and installation of said vehicle sub frame from and upon a host vehicle.

2. A method for removing a vehicle subframe, having a first subframe crossmember and a second subframe crossmember together with a pair of spaced apart subframe side members, from a host vehicle using a jack apparatus which includes a vertically movable pedestal, said method comprising the steps of:
providing a tool for removal and installation of a vehicle sub frame, said tool including a center spine having a first end, a second end and an upper surface, a mounting pad, defining a plurality of apertures, secured to said center spine, a tool crossmember defining a channel having upwardly extending sidewalls on either side thereof, a bracket having a pair of upwardly extending bracket walls and means for adjusting a space defined between said upwardly extending walls, and adjustable attachment means operative between said bracket and said center spine to vary the distance between said crossmember and said bracket;
securing said tool to a jack pedestal;
positioning said tool while secured to said jack pedestal beneath a host vehicle having a removable subframe such that said first subframe crossmember is received within said tool crossmember and such that said second subframe crossmember is received between said bracket walls;
raising said jack pedestal and said tool upwardly against the vehicle subframe to support the vehicle subframe within said tool; and
supporting said vehicle subframe upon said tool during removal and installation of said vehicle subframe from and upon a host vehicle.

3. A method for installing a vehicle subframe, having a first subframe crossmember and a second subframe crossmember together with a pair of spaced apart subframe side members, upon a host vehicle using a jack apparatus which includes a vertically movable pedestal, said method comprising the steps of:
providing a tool for removal and installation of a vehicle sub frame, said tool including a center spine having a first end, a second end and an upper surface, a mounting pad, defining a plurality of apertures, secured to said center spine, a tool crossmember defining a channel having upwardly extending sidewalls on either side thereof, a bracket having a pair of upwardly extending bracket walls and means for adjusting a space defined between said upwardly extending walls, and adjustable attachment means operative between said bracket and said center spine to vary the distance between said crossmember and said bracket;
securing said tool to a jack pedestal;
placing said subframe upon said tool such that said first subframe crossmember is received within said tool crossmember and such that said second subframe crossmember is received between said bracket walls;
positioning said tool while secured to said jack pedestal beneath a host vehicle such that said first subframe crossmember within said tool crossmember and such that said second subframe crossmember between said bracket walls are aligned with the vehicle for attachment;
raising said jack pedestal and said tool upwardly while supporting the vehicle subframe within said tool against the vehicle; and
supporting said vehicle subframe upon said tool during installation of said vehicle subframe upon a host vehicle.
